(19) United States
(12) Patent Application Publication
(10) Pub. No.: US 2018/0194565 A1
(43) Pub. Date: Jul. 12, 2018

(54) Edge Drive System for Conveyor Belts and Method for Driving a Conveyor Belt

(71) Applicant: Habasit AG, Reinach (CH)

(72) Inventors: Dietmar ELSNER, Eimeldingen (DE); Thomas Dingnis, Metzelen (CH)

(21) Appl. No.: 15/400,949

(22) Filed: Jan. 6, 2017

(51) Int. Cl. B65G 23/16

(52) U.S. Cl. CPC B65G 23/16

(57) ABSTRACT

An edge-drive system for a conveyor is provided. The system comprises a drive motor and a first drive belt operably connected to the drive motor. The first drive belt includes a plurality of mating portions configured to interdigitate with corresponding mating portions of a first edge of a conveyor belt. In this way, advancing the drive belt using the drive motor will propel the conveyor belt by way of engagement of the mating portions at the edge of the conveyor belt. The mating portions of the first drive belt may be, for example, teeth affixed to the first drive belt. The system may include a second drive belt to engage the conveyor belt from a second edge, which is opposite the first edge.

### FIELD OF THE DISCLOSURE

The present disclosure relates to modular conveyors, and more particularly, to drive systems for modular conveyors.

### BACKGROUND OF THE DISCLOSURE

Conveyor belt drive systems using sprockets are traditionally located beneath the driven belt. This arrangement requires a space beneath the belt, which increases the total height of the complete conveyor system. This may result in a reduction in usable space above the belt-space that can be used to convey materials. In some cases, certain areas of the conveyor cannot be used to transport materials. Other previous drive systems using, for example, chains (see, e.g., FIGS. 1 and 2), require lubrication, which can create hygiene issues when used in the food industry.

Additionally, each transfer point can possibly damage the product being conveyed. The clear trend in the industry is to use longer conveyors, which require belts with higher strength. This is difficult to achieve with belts for radius applications because when the belt is running through a curve, the whole traction force is moved to the outermost belt edge. Clearly, this effect limits the maximum possible belt length. Today, in order to counteract such increased drive forces, conveyor systems are typically split into sections, each section having a separate belt. Conveyed materials are transferred from a first belt to a second belt at a transfer point. However, such transfer points have the potential to damage the conveyed materials, and are therefore to be avoided. Moreover, additional drive motors are needed if conveyor systems are split into more than one conveyor.

### BRIEF SUMMARY OF THE DISCLOSURE

An edge-drive system is presented to overcome the above-mentioned problems. Such a drive system is located at each edge of a conveyor belt, thereby eliminating the need for additional height to accommodate the drive. The low profile also advantageously allows such an edge-drive system to be used to supplement movement of a long and/or radius conveyor because such a drive system can be located at points of a conveyor where traditional drives could not be used. In this way, use of the presently-disclosed drive system can reduce the number of transfer points of a conveyor system using split belts.

### DESCRIPTION OF THE DRAWINGS

For a fuller understanding of the nature and objects of the disclosure, reference should be made to the following detailed description taken in conjunction with the accompanying drawings, in which:

FIG. 1 is a prior art chain drive system for a conveyor belt;

FIGS. 2A and 2B depict engagement of a prior art chain drive with a conveyor belt;

FIG. 3 shows an exemplary edge-drive system according to an embodiment of the present disclosure, shown engaged with a portion of a conveyor belt;

FIG. 4 is another view of the exemplary edge-drive system of FIG. 3;

FIG. 5 depicts an edge-drive system according to another embodiment of the present disclosure, shown engaged with a portion of a conveyor belt;

FIG. 6 is a detailed top view of a location where a tooth of a drive belt engages with a belt module;

FIG. 7 is a detailed perspective view of the location where a tooth of the drive belt of FIG. 6 disengages from the belt module;

FIG. 8 is a perspective view of a portion of the drive belt of FIGS. 6 and 7;

FIG. 9 is a detailed view of a portion of a drive belt, a portion of a conveyor belt, and a tooth with a semi-circular notch attached to the drive belt configured to engage with the conveyor belt portion;

FIG. 10 is a perspective view of the drive belt portion, conveyor belt portion, and tooth of FIG. 9;

FIG. 11 is a side view of a variation of the drive belt portion, conveyor belt portion, and tooth of FIGS. 9 and 10, wherein the semi-circular notch of the tooth is of greater diameter than the width of the engaging portion of the conveyor;

FIG. 12 is a perspective view of the drive belt portion, conveyor belt portion, and tooth of FIG. 11;

FIG. 13 is a perspective view of a drive belt portion, a conveyor belt portion having a recess, and a tooth having a triangular section engaged with the recess of the conveyor belt;

FIG. 14 is a perspective view of the drive belt portion, conveyor belt portion, and tooth of FIG. 13, wherein the conveyor belt portion is disengaged from the tooth;

FIG. 15 is a detailed view of a portion of the drive belt, a first conveyor belt portion, a second belt conveyor portion, and a tooth according to a first embodiment of the present disclosure engaging the edge of the belt module;

FIG. 16 is a detailed view of the drive belt portion, conveyor belt portions, and tooth of FIG. 15, wherein the tooth is engaged with the first conveyor portion;

FIG. 17 is a detailed view of the drive belt portion, conveyor belt potions, and tooth of FIG. 15, wherein the tooth is engaged with the second conveyor portion;

FIG. 18 is a side view of a drive belt portion, a conveyor belt portion, and a tooth having a shoulder wherein the flat side of the tooth engages with conveyor belt portion;

FIG. 19 is a side view of a drive belt portion, a conveyor belt portion, and a shouldered tooth wherein the shouldered side of the tooth engages with conveyor belt portion;

FIG. 20 is a perspective view of the drive belt portion, conveyor belt portion, and shouldered tooth of FIG. 19;

FIG. 21 is a perspective view of an edge drive system where the drive belt includes mating portions which are recesses (note that the depiction is simplified and does not show all recesses of the drive belt);

FIG. 22 is a perspective view of the drive belt of FIG. 21;

FIG. 23 is a perspective view of a portion of a conveyor belt, a sprocket, and a portion of a drive belt, wherein the drive belt is a drive chain configured to engage with both the recesses of the sprocket and the recesses of the conveyor belt;

FIG. 24 is a side view of the drive chain portion and the conveyor belt portion from FIG. 23;

FIG. 25 is a perspective view of a portion of a conveyor belt, a sprocket, a ramp, and a portion of a drive belt, where the drive belt is a chain with rotating shafts having teeth configured to engage the bottom side of the conveyor belt;

FIG. 26 is a perspective view of a sprocket, a ramp, and a portion of a drive belt, where the drive belt is a chain with rotating shafts having teeth configured to engage the bottom side of a conveyor belt;

FIG. 27 is a side view of a portion of a conveyor belt, a ramp, and a portion of a drive belt, where the drive belt is a chain with rotating shafts having teeth configured to engage the bottom side of the conveyor belt, and the teeth only engage the conveyor belt when angled as shown in the figure;

FIG. 28A is a perspective view of a portion of a drive system according to another embodiment of the present disclosure where the drive belt is a modular belt;

FIG. 28B is a side view of the drive system of FIG. 28A;

FIG. 28C is a top view of the drive system of FIGS. 28A and 28B;

FIG. 29 is a perspective view of an edge drive system where the drive belt is a toothed timing belt having a plurality of notched teeth configured to engage the conveyor belt;

FIG. 30 is a detailed view of a portion of a conveyor belt;

FIG. 31 is a perspective view of a portion of a dual edge drive system further compromising a guide for each edge of the conveyor belt;

FIG. 32 is a perspective view of a portion of a dual edge drive system further compromising a guide for each edge of the conveyor belt;

FIG. 33 is a side view of a portion of a single edge driver system with a secondary belt drive system;

FIG. 34 is a perspective view of a portion of a dual edge drive system with a secondary belt drive system;

FIG. 35 is a portion of a prior art conveyor with more than one tier of conveyor belt;

FIG. 36 is another portion of the conveyor of FIG. 35, showing a drive motor and drive systems located beneath the belt of each tier;

FIG. 37 is a chart of a method according to another embodiment of the present disclosure.

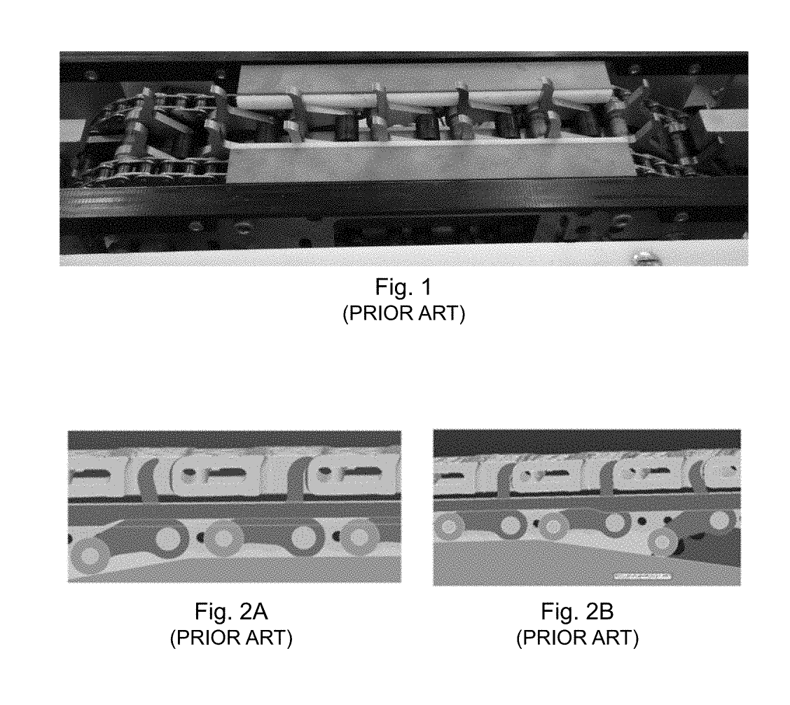

### DETAILED DESCRIPTION OF THE DISCLOSURE

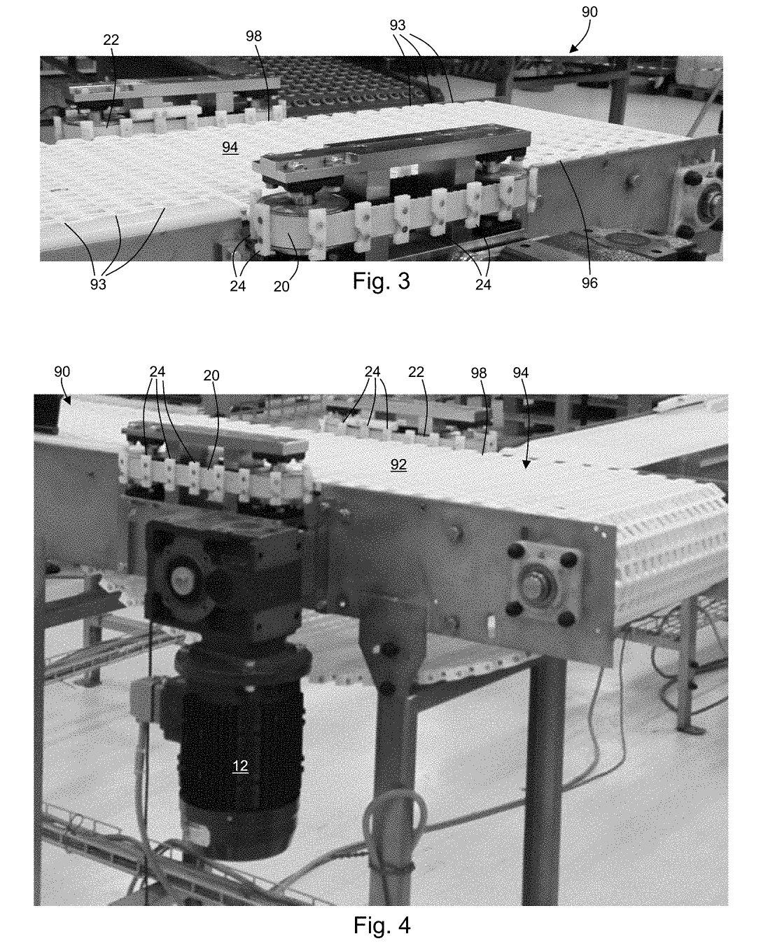

In a first aspect, the present disclosure may be embodied as a drive system 10 for a conveyor 90. The conveyor 90 may have an “endless” conveyor belt 92 made up of a plurality of belt modules 93, as is commonly known in the art, with a conveying surface 94 and belt edges 96, 98. The drive system 10 comprises a drive motor 12 operably connected to a first drive belt 20. In some embodiments, the drive system 10 may have more than one drive motors 12 and/or drive belt 20. In the exemplary embodiment depicted in FIGS. 3 and 4, the drive system 10 includes two drive belts—a first drive belt 20 and a second drive belt 22—connected to one drive motor 12. For convenience, reference is made to the exemplary embodiment through the remainder of the disclosure. However, the disclosure should not be limited to embodiments with two drive belts. In embodiments with two drive belts 20, 22, the first drive belt 20 is configured to engage a first edge 96 of the conveyor belt 92 and the second drive belt 22 is configured to engage a second edge 98 of the conveyor belt 92, which is opposite the first edge 96. The drive belt(s) may be operably connected to the motor(s) through the use of additional components such as sprockets, gears, connecting rods, transmissions, and the like, as will be apparent to one having skill in the art in light of the present disclosure.

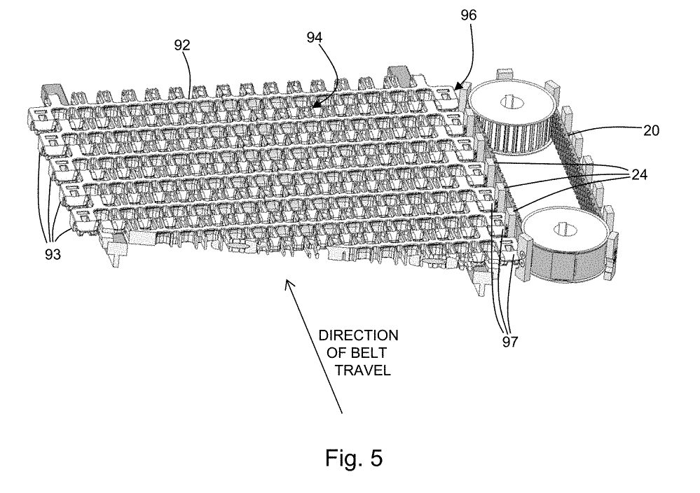

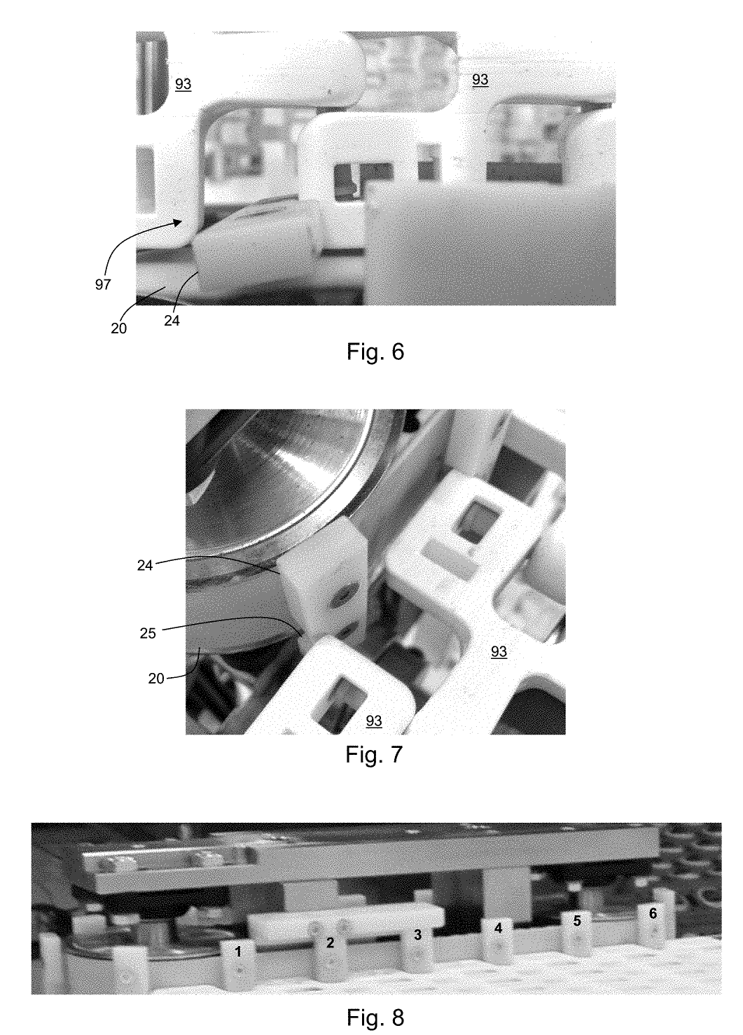

The first drive belt 20 is disposed on a side of the conveyor belt 92, so as to engage a first edge 96 of the conveyor belt 92. The first drive belt 20 comprises a plurality of mating portions configured to engage with corresponding mating portions of the first edge 96 of the conveyor belt 92. For example, the mating portions may be configured as a plurality of teeth 24, wherein each tooth 24 of the plurality of teeth 24 of the drive belt 20 engages a corresponding mating portion formed by an end 97 of each belt module 93 of the conveyor belt 92 (see, for example, FIGS. 5 and 6). In this way, when the drive belts 20, 22 are driven by the drive motor 12, the teeth 24 urge movement of the belt modules 93 to drive the conveyor belt 92 in a direction of belt travel. In some embodiments of the edge-drive system, the drive belt(s) may be configured to urge the conveyor belt in either a forward or a backward direction depending on the desired direction of movement. The drive belt may be located at a straight portion of the conveyor. In another embodiment, the drive belt(s) may be located at an inside curve and/or an outside curve of a radius conveyor belt (i.e., a conveyor belt that traverses a turn).

By “engaging” the edges of the conveyor belt 92 (or engaging the edge portion of a belt module 93), each tooth 24 enters a gap between the belt module ends 97 (see, e.g., FIG. 6). The tooth 24 contacts the belt module 93 to apply a driving force to the belt module 93 in a direction of belt travel. In some embodiments, such as that detailed in FIGS. 6-8, each consecutive tooth 24 engages with a corresponding consecutive belt module 93. In other embodiments, the teeth of the drive belt may engage every second belt module (or other multiples of belt modules, for example, every third module).

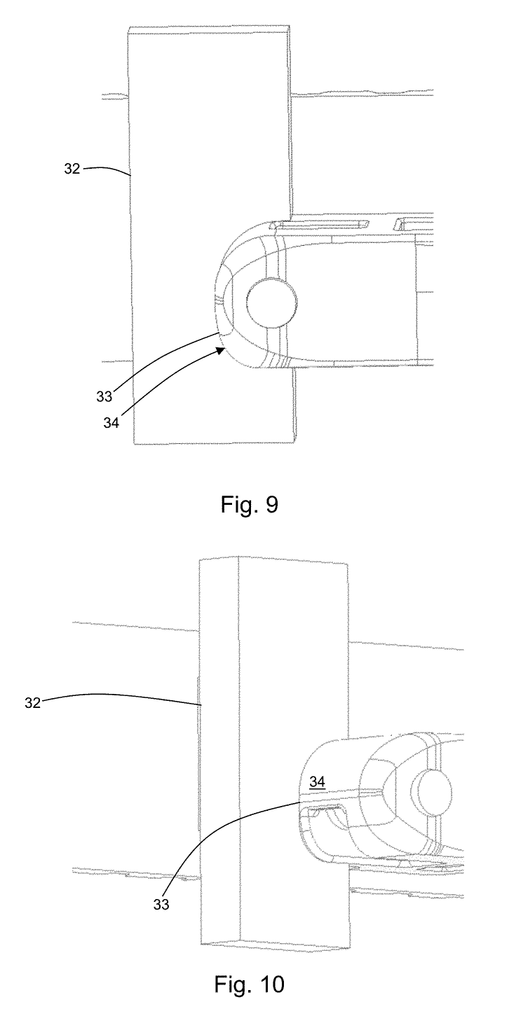

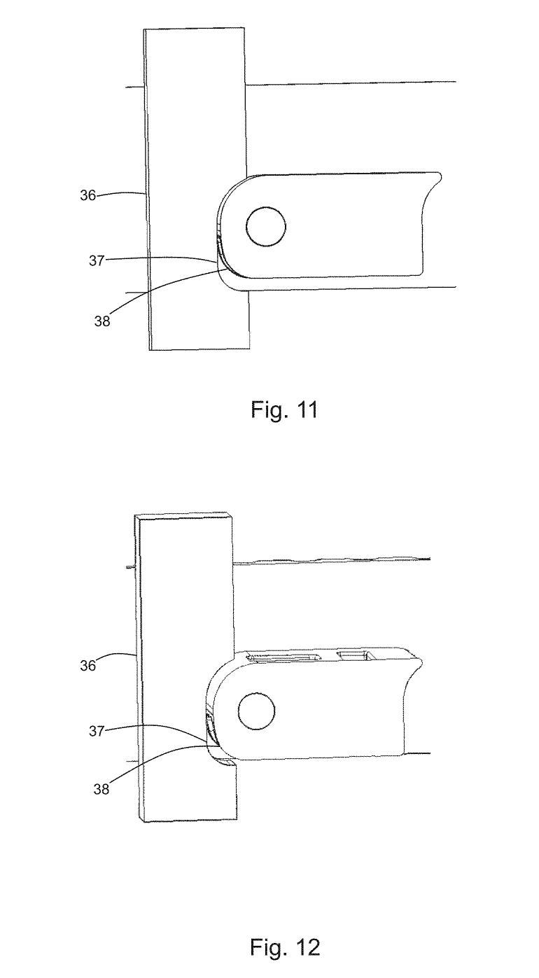

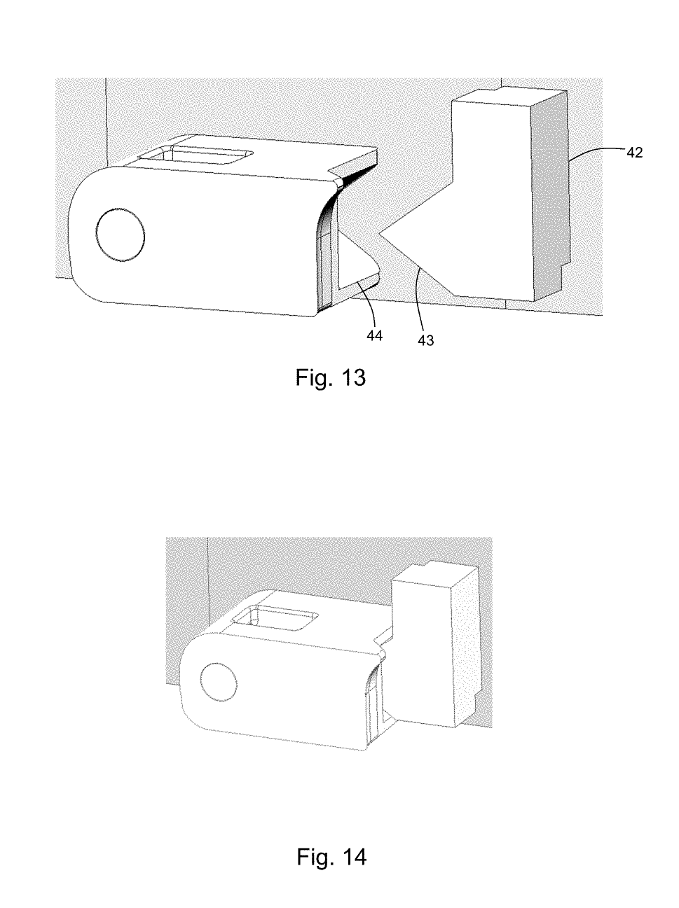

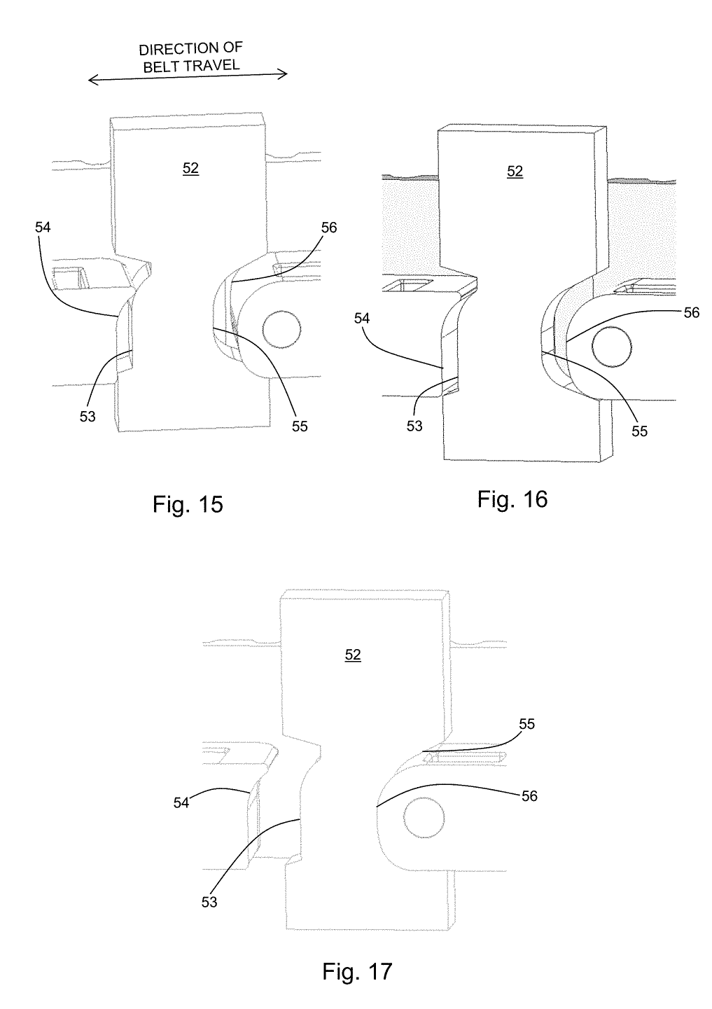

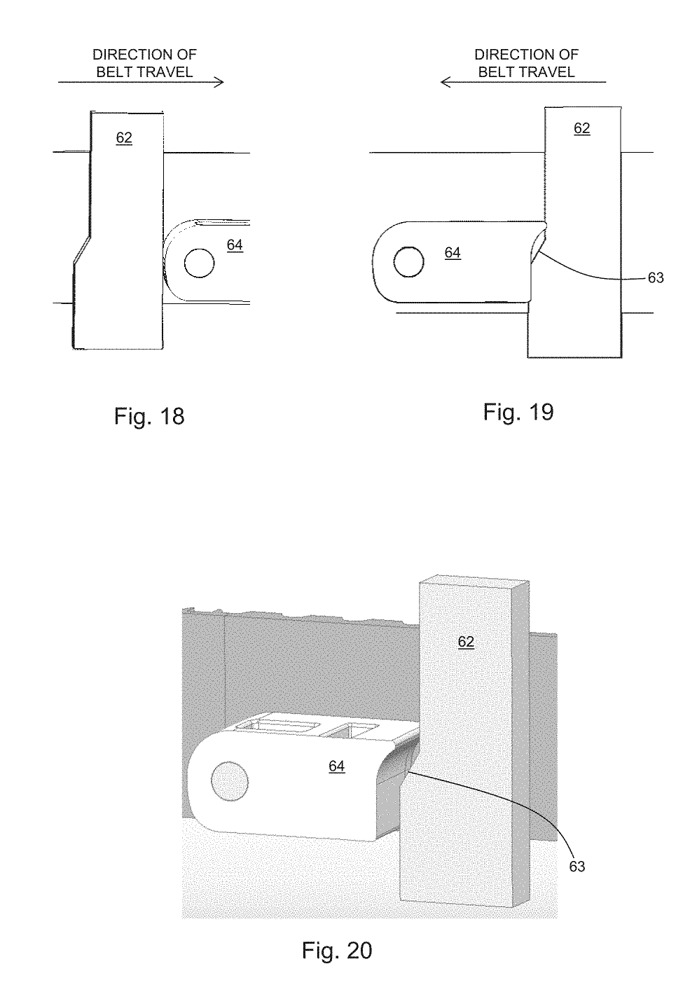

The teeth 24 may be shaped for improved engagement with the belt modules 93. For example, each tooth 24 may have a notch 25 configured to reduce movement between the belt module 93 and the tooth 24 (for example, to reduce a tendency of a belt module from sliding on an engaging surface of the tooth) (see, for example, FIG. 6). The shapes of the notches may be selected to correspond with the shape of the associated belt module end. For example, in the embodiment depicted in FIGS. 9 and 10, the notch 33 of each tooth 32 is generally semi-circular to cooperate with the belt module end 34. FIGS. 11 and 12 depict an embodiment similar to the embodiment of FIGS. 9 and 10, except that the notch 37 of the tooth 36 has a greater diameter than the engaging portion of the belt module end 38. FIGS. 13 and 14 depict another example, wherein the tooth 42 includes an angular notch 43 to cooperate with the corresponding belt module end 44. In some embodiments, each tooth may contain more than one notch to engage the conveyor belt and urge movement in either a forward or rearward direction of belt travel. For example, in the embodiment depicted in FIGS. 15-17, the tooth 52 includes a first notch 53 corresponding to a first engaging portion of a belt module end 54, and the tooth 52 includes a second notch 55 corresponding to a second engaging portion of a belt module 56. While the shape of a notch may closely conform to the corresponding shape of a belt module end, such close conformity is not required. For example, in the embodiment depicted in FIGS. 18-20, a tooth 62 may drive a conveyor belt in a forward or rearward direction of belt travel without close conformity between a notch 63 of the tooth 62 and the corresponding belt module end 64. In FIG. 18, a notchless side of the tooth 62 contacts the belt module end 64 to impart motion in a first direction of belt travel. In FIGS. 19-20, the tooth 62 includes a notch 63 configures as a shoulder to contact the belt module end 64 and impart motion in a second direction of belt travel.

Each drive belt has a pitch—i.e., corresponding to a spacing of the teeth. Similarly, the conveyor belt has a pitch corresponding to the spacing of the belt modules. In some embodiments, the pitch of the drive belts is the same as the pitch of the conveyor belt. In other embodiments, the pitch of the drive belts is less than the pitch of the conveyor belt. For example, the pitch of the drive belts may be greater than or equal to 95% of the pitch of the conveyor belt. The pitch ratio (between the drive belt pitch and the conveyor belt pitch) may be more or less than 95%. In an exemplary embodiment constructed for testing purposes, the pitch of the drive belts was 50 mm and the pitch of the conveyor belt was 50.8 mm. As the pitch of the drive belt approaches that of the conveyor belt, disengagement of the conveyor belt modules from the teeth of the drive belt may become problematic due to the angular velocity of the teeth at the point of disengagement. The conveyor belt may be pushed forward at the location of disengagement and be subject to stresses.

The teeth of the drive belts may be made of any material suitable for such purposes as will be apparent to those skilled in the art in light of the present disclosure. For example, the teeth may be made of a rigid plastic. In other embodiments, the teeth are made from elastic materials, such as, for example, thermoplastic polyurethane (“TPU”). Among other benefits of teeth made from elastic materials, such teeth may reduce noise and/or vibration. Another benefit of a softer material is that the elasticity will provide more assurance that more than one tooth of the drive belt will engage the conveyor belt—the pitch of the driving device will “adapt” under tension to the pitch of the driven belt. The teeth may be made from more than one material.

The teeth of a drive belt may be molded onto the drive belt. For example, the teeth and drive belt may molded simultaneously. In another example, the teeth may be overmolded onto an existing drive belt. In some embodiments, teeth are affixed to a drive belt using a fastener, such as a screw, adhesive, or other known techniques or combinations of techniques. The teeth may be welded to the drive belt.

Each drive belt 20, 22 may be operably connected to the same drive motor 12. For example, each drive belt 20, 22 may be connected to the drive motor 12 by way of a beveled gear. Other components for mechanical linkage may be used for operable connection between the drive belts and the drive motor, including, but not limited to drive shafts, pulleys, transmissions, gears, belts, etc. In some embodiments, the drive belts are driven at the same speed. In other embodiments, the drive belts have speeds which differ from one another.

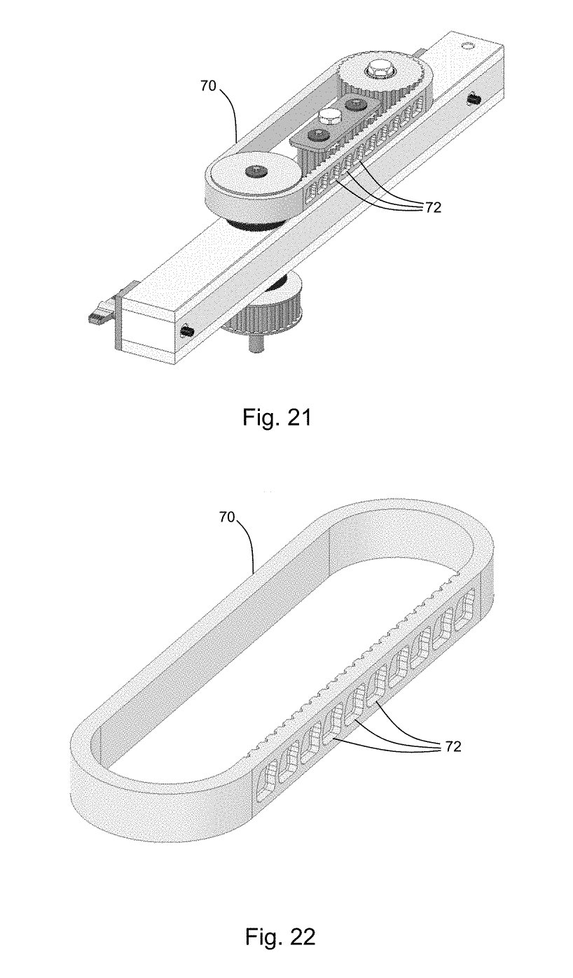

Although the present disclosure has been described using the exemplary embodiment wherein the mating portions of the drive belt are teeth, it should be noted that other techniques for engagement are contemplated and included in the broadest embodiment of the present edge-drive system. For example, the mating portions of a drive belt may be recesses, each recess configured to engage a corresponding end of a conveyor belt module. In a particular example, the first drive belt 70 of the embodiment depicted in FIGS. 21 and 22, includes a plurality of recesses 72. Each recess 72 is configured to engage a corresponding end portion of a belt module (not shown). In some embodiments, the drive belt is a modular belt comprised of a plurality of drive belt modules.

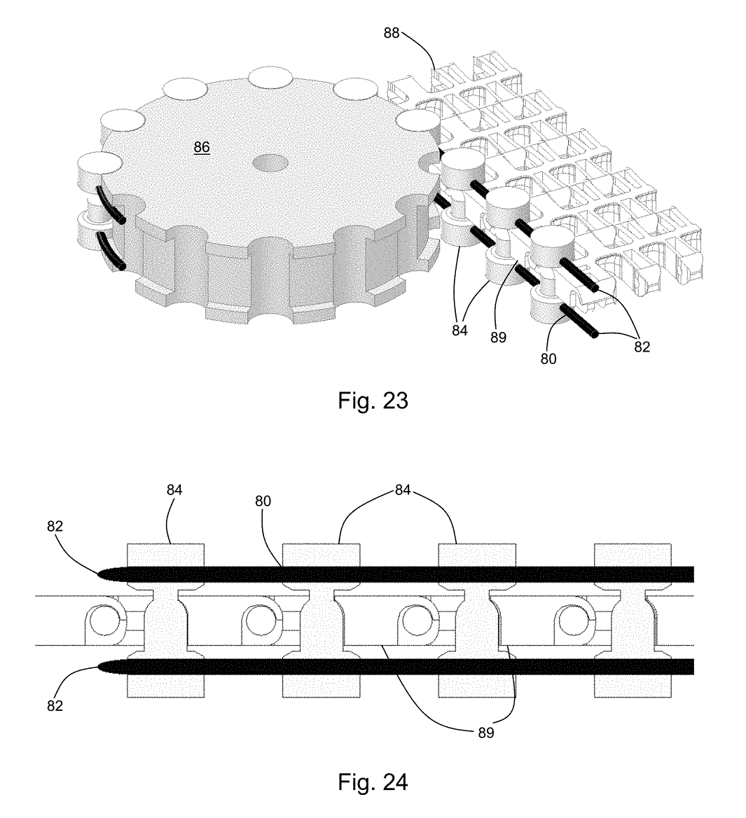

In another example, the drive belt may be a chain having mating portions in the form of links to engage the edge of a conveyor belt. In the embodiment depicted in FIGS. 23 and 24, the drive belt is a chain 80 made up of one or more cables 82. The mating portions of such a chain drive belt 80 may be a plurality of links 84, wherein each link 84 is affixed to the one or more cables 82. The links 84 of the chain 80 are engaged with a sprocket 86 to propel the chain 80. The links 84 also engage with the edge 89 of the conveyor belt 88 to propel the conveyor belt. It should be noted that FIGS. 23 and 24 depict an exemplary embodiment of a chain drive. Other embodiments will be apparent to one having skill in the art in light of the present disclosure.

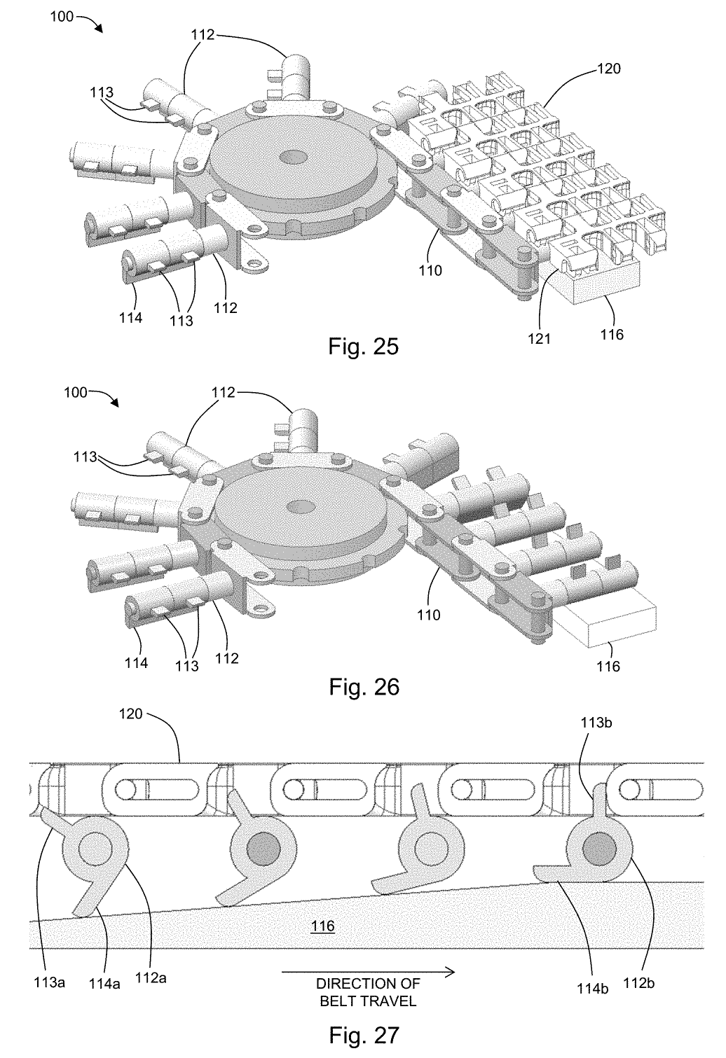

In another exemplary embodiment depicted in FIGS. 25-27, the drive belt may be a chain 110, and the mating portions of the belt are a plurality of shafts 112, each shaft 112 having one or more teeth 113 configured to engage an underside of a conveyor belt 120 at an edge 121. Each shaft 112 is configured to be rotatable about a primary longitudinal axis of the shaft 112. The system 100 may include a ramp 116 for engaging a cam or lever 114 of each shaft 112 causing the shaft 112 to rotate. FIG. 27 shows how the ramp 116 contacts the levers 114 as each shaft 112 moves in the direction of belt travel. As a shaft 112a moves across the ramp 116, the lever 114a is initially moved upwards such that the teeth 113a are moved into engagement of the conveyor belt 120. Once the teeth 113 are engaged with the conveyor belt 120 (shown by shaft 112b, teeth 113b, and lever 114b), the corresponding lever 114 is held in position until the end of the drive, where ramp 116 allows the shafts 112 to rotate back to a disengaged configuration.

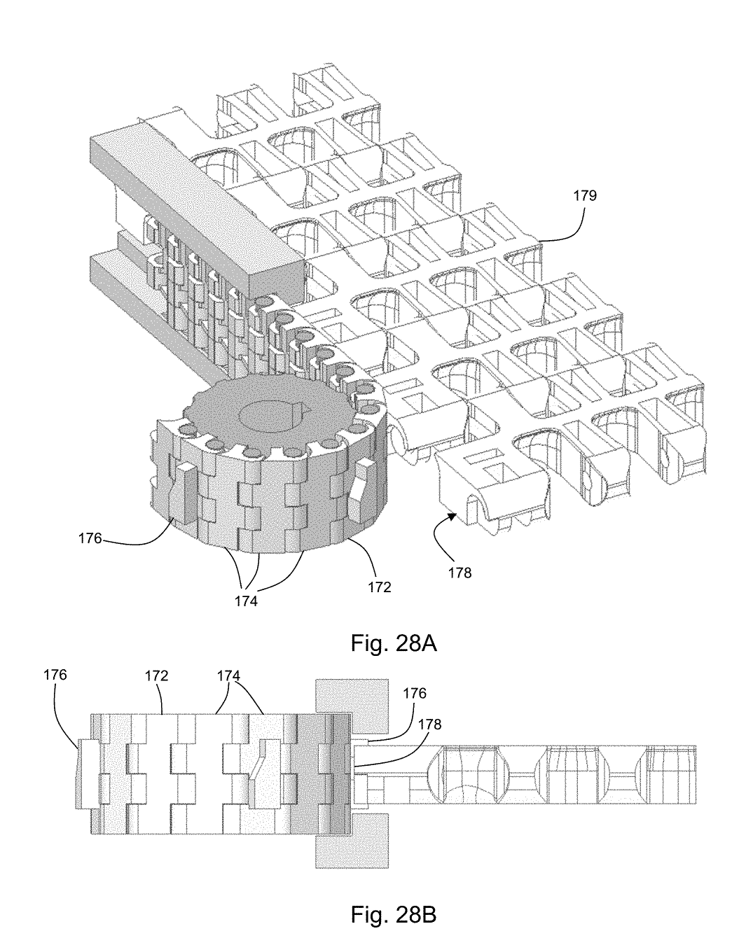

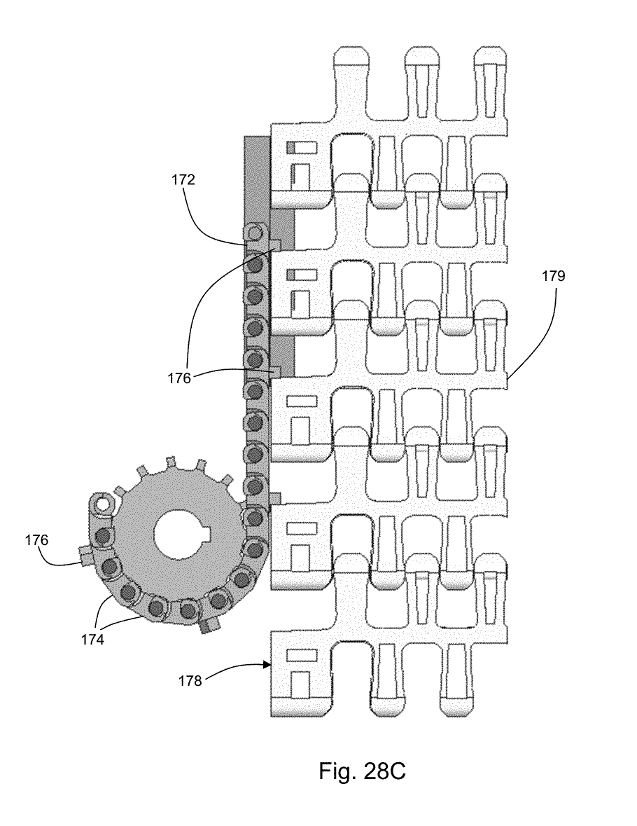

In another embodiment of the present drive system, the drive belt is a modular belt 172 (see FIGS. 28A-28C). The modular belt 172 comprises a plurality of drive modules 174 linked together to form the belt. The drive modules 174 include mating portions 176 for engaging the edge 178 of the conveyor belt 179. The mating portions can be attached to the drive modules, integrally formed with the drive modules, formed into the drive modules, or other configurations as are described herein. Embodiments of a modular drive belt may have mating portions on every drive module or regularly spaced on drive modules. For example, in the embodiment depicted in FIGS. 28A-28C, the mating portions 176 are on every fourth drive module 174.

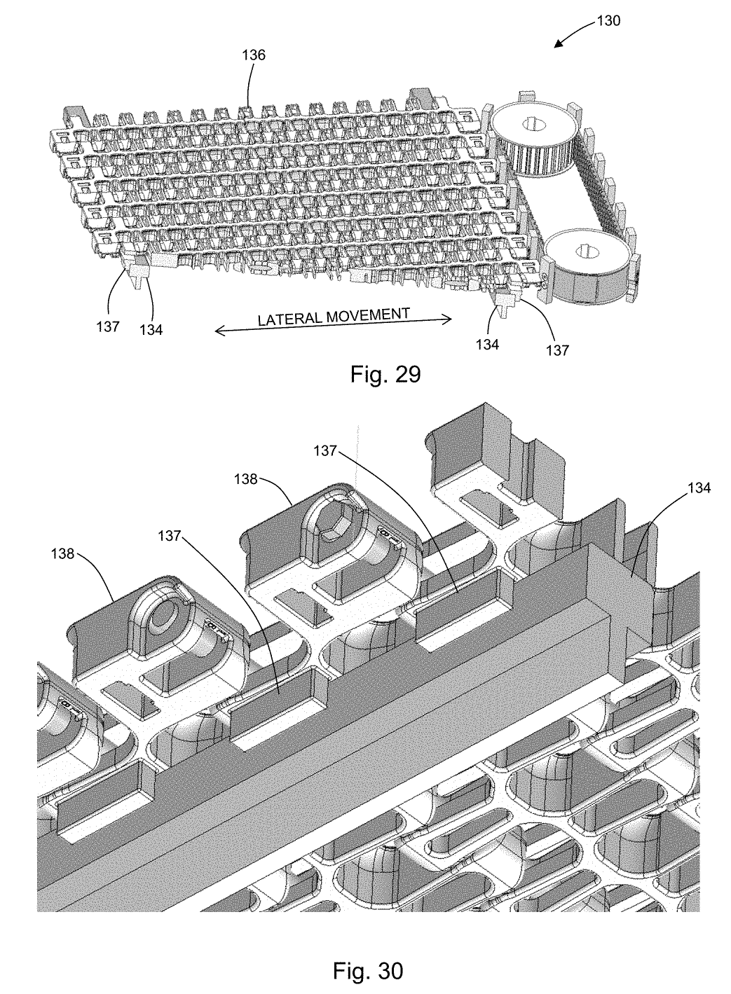

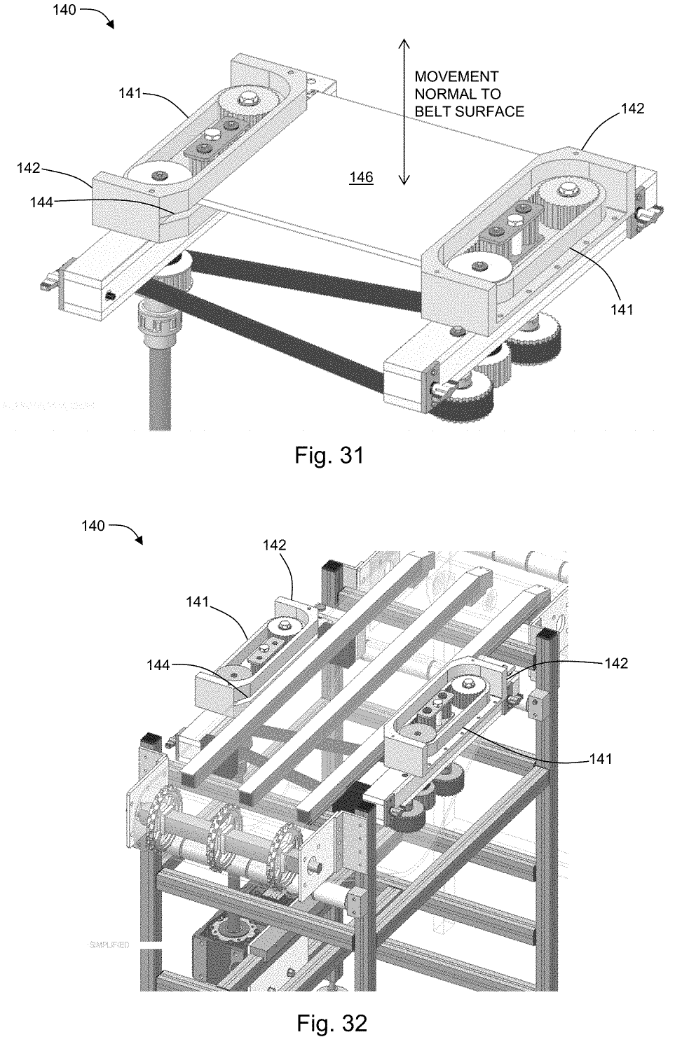

In conveyor applications with high loads, it may be advantageous to prevent lateral movement of the conveyor belt. As such, a drive system 130 may further comprise one or more lateral guides 134 configured to engage with corresponding rib(s) 137 of the conveyor belt 136 (i.e., ribs 137 of the belt modules 138) (see, for example, the embodiment depicted in FIGS. 29 and 30). For example, embodiments may include a lateral guide below and/or above the conveyor belt to avoid the conveyor belt being moving laterally away from the drive belt. Similarly, it may be advantageous to prevent movement of the conveyor belt in a direction normal to the belt surface so that the conveyor belt edge does not slip off of the drive belt mating portions. As such, a drive system 140 may further comprise one or more edge guides 142 (see FIGS. 31 and 32). Each edge guide 142 having a slot 144 through which an edge of the conveyor belt 146 can pass. In this way, an edge of the conveyor belt 146 can extend through the slot 144 to engage with a drive belt 141 and move in a direction of belt travel, while also preventing movement of the edge in a direction normal to the conveyor belt surface.

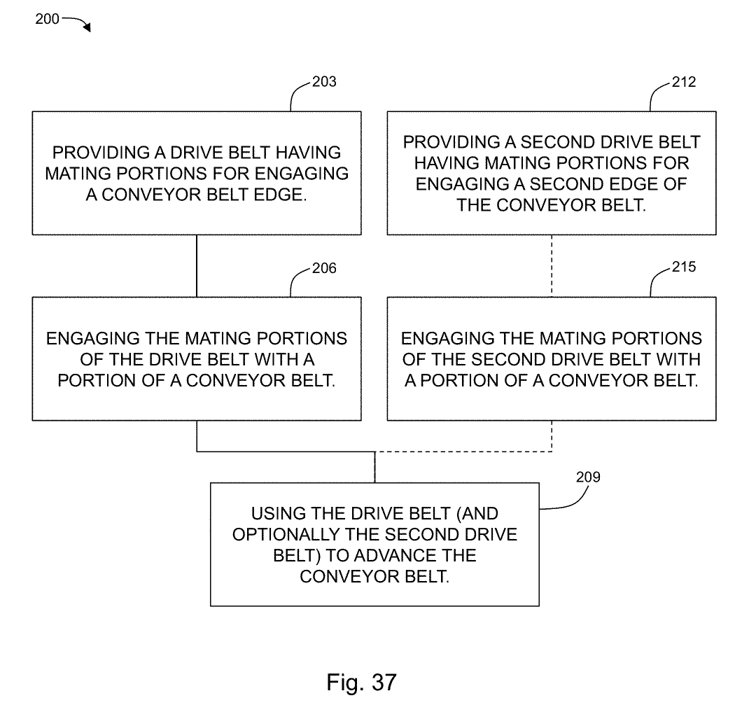

In another aspect, the present disclosure is embodied as a method 200 for driving a conveyor belt (see FIG. 37). Such a method 200 comprises providing 203 a drive belt of any of the configurations disclosed herein. For example, a first drive belt may be provided 203, the first drive belt having a plurality of mating portions, wherein the mating portions are configured for engaging an edge of a modular conveyor belt. A first edge of a modular conveyor belt is engaged 206, and the drive belt is used to advance 209 the conveyor belt. For example, the drive belt may be used 209 to advance the conveyor belt by moving the drive belt with a drive motor. The method 200 may further comprise providing 212 a second drive belt and engaging 215 second drive belt with a second edge of the modular conveyor belt, opposite the first edge. In such an embodiments, the drive belt and the second drive belts are used 209 to advance the conveyor belt.

### Further Description of Operation:

FIG. 6 shows the point where a tooth 24 of the drive belt 20 engages a belt module 93 of the conveyor belt. Generally, when a tooth of the drive belt first engages with a belt module, the tooth takes up a majority of the load from those teeth already engaged with belt modules of the conveyor belt. In an exemplary embodiment having a drive belt pitch of 50 mm and a conveyor belt pitch of 50.8 mm, there would, theoretically, be a gap which would increase in size from link-to-link by 0.8 mm. However, in practice, the gap does not exist because the linking rods of a typical conveyor are flexible and therefore bend to accommodate the difference in pitch. This allows a more even distribution of the load across the engaged teeth of the drive belt.

At the end of the drive, each tooth 24 sequentially disengages from it corresponding belt module 93 (see FIG. 7). In the exemplary embodiment of a drive belt depicted in FIGS. 6-8, there are six teeth in operation (engaged with the conveyor belt at a time), therefore, there is a theoretical clearance of 6×0.8 mm=4.8 mm. However, FIG. 7 shows that the actual clearance is much less. An exemplary reason for this difference between the theoretical gap and the actual is that the links of the belt module can bend backwards. Also, in the test installation depicted in FIGS. 6-8, only one drive belt was used.

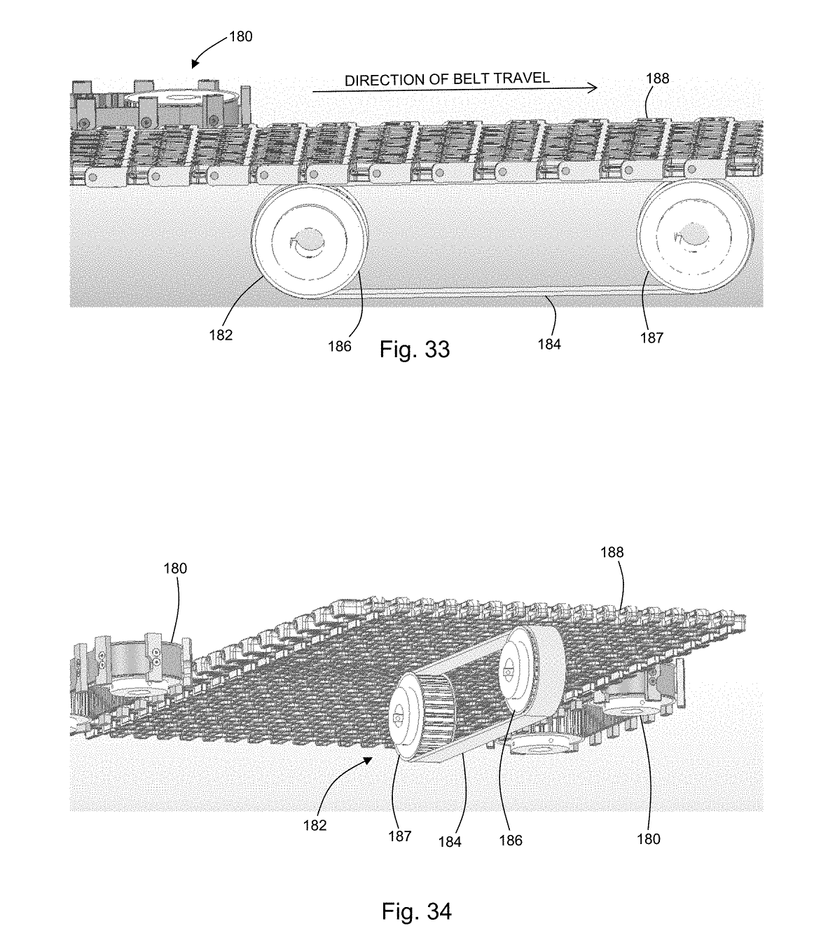

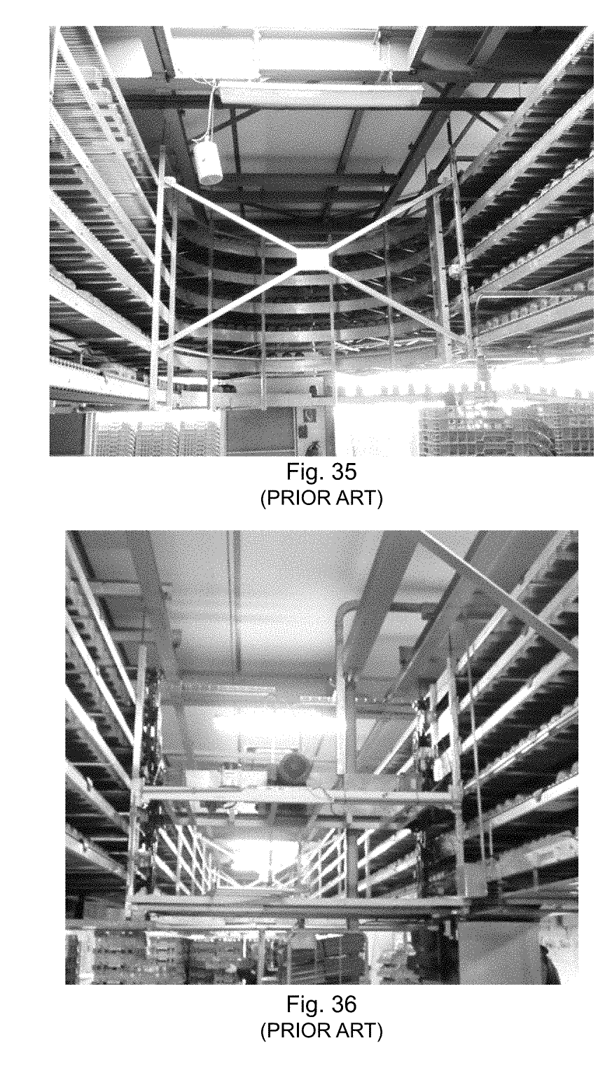

The portion of the conveyor belt just after the drive system may not be under tension. Therefore, the tendency of the conveyor belt to stop moving after the drive may be quite high. One way to mitigate this tendency is to use a heavy catenary sag. The weight of the conveyor belt at the sag advantageously pulls the conveyor belt with a more constant force, which is preferably higher than the frictional force on the conveyor belt between the exit of the drive system and idling shaft. Another option to prevent this movement is the use of a supplementary belt drive below the conveyor belt. FIGS. 33 and 34 depict an embodiment of a supplementary belt drive 182 below the conveyor belt 188. The supplementary belt drive 182 comprises a supplemental belt 184, a drive sprocket 186, and an idler sprocket 187. The drive sprocket 186 is in mechanically connected to a motor (not shown) for rotating the drive sprocket 186 and imparting movement in the belt 184. The belt 184 of such a supplementary belt drive 182 runs at the same speed as the conveyor belt 188. The friction between this supplemental belt 184 and the conveyor belt 188 prevents the conveyor belt 188 from stopping at the exit of the drive system 180.

At points along a conveyor, the conveyor belt may have a configuration where the pitch of the belt at a first edge is different than the pitch of the belt at a second edge. For example, during a turn of a radius belt, or just afterwards, the belt pitch may be different from belt edge to belt edge. For this reason, drive belts on opposite sides of a conveyor belt may require different configurations from one another (e.g., differing pitch, etc.) This different configuration of drive belts may be unnecessary if the drive is located at a distance from a curve. However, locating the drive away from a curve may not be practical. For example, in embodiments of conveyors with more than one tier, those depicted in FIGS. 35 and 36, it may be beneficial to utilize a single drive motor connected to multiple drive systems by way of drive shafts, each drive system on a different tier of the conveyor. As such, it may not be realistic to assume that the conveyor belt will be in the same configuration on each tier of the conveyor. As such, even if no drive belt adjustment is needed after a curve of the first tier, adjustment may be necessary on subsequent tiers.

Although the present disclosure has been described with respect to one or more particular embodiments, it will be understood that other embodiments of the present disclosure may be made without departing from the spirit and scope of the present disclosure. Hence, the present disclosure is deemed limited only by the appended claims and the reasonable interpretation thereof.

1. A drive system for a conveyor, comprising:
a drive motor; and
a first drive belt operably connected with the drive motor, the first drive belt having a plurality of mating portions configured to interdigitate with corresponding mating portions of a first edge of a conveyor belt to urge movement of the conveyor belt.

2. The drive system of claim 1, further comprising a second drive belt operably connected with the drive motor and configured to engage a second edge of the conveyor belt, opposite the first edge, the second drive belt having mating portions configured to engage the second edge of the conveyor belt.

3. The drive system of claim 2, wherein a pitch of the first drive belt is different from a pitch of the second drive belt.

4. The drive system of claim 2, wherein a speed of the first drive belt is equal to a speed of the second drive belt.

5. The drive system of claim 1, wherein the mating portions are teeth.

6. The drive system of claim 5, wherein the teeth are molded on the first drive belt.

7. The drive system of claim 5, wherein the teeth are affixed to the first drive belt with fasteners and/or adhesive.

8. The drive system of claim 5, wherein the teeth are affixed to the first drive belt by welding.

9. The drive system of claim 5, wherein the teeth are made from an elastic material.

10. The drive system of claim 5, wherein each tooth has a notch to engage an end of a belt module of the conveyor belt.

11. The drive system of claim 1, wherein the first drive belt is operably connected with the drive motor by way of a beveled gear.

12. The drive system of claim 1, wherein the mating portions are recesses configured to engage an end of a belt module of the conveyor belt.

13. The drive system of claim 1, wherein the first drive belt is a timing belt and the mating portions are formed into the timing belt.

14. The drive system of claim 1, wherein the first drive belt is an endless belt.

15. The drive system of claim 1, wherein the first drive belt is a modular belt comprising a plurality of drive modules and the drive modules include the mating portions.

16. The drive system of claim 1, wherein the first drive belt is a chain and the mating portions are links of the chain.

17. The drive system of claim 16, wherein the chain comprises one or more cables.

18. The drive system of claim 1, wherein the first drive belt is a chain, and each mating portion of the plurality of mating portions is a rotatable shaft having teeth configured to selectively engage an underside of the first edge of the conveyor belt.

19. The drive system of claim 18, further comprising a ramp configured to rotate the rotatable shafts.

20. The drive system of claim 1, further comprising a supplementary belt drive at an exit of the first drive belt, the supplementary belt drive configured to contact an underside of the conveyor belt to prevent the conveyor belt from stopping at the exit of the first drive belt.

21. The drive system of claim 1, further comprising a lateral guide configured to engage with a rib of the conveyor belt to prevent lateral movement of the conveyor belt.

22. The drive system of claim 1, further comprising an edge guide having a slot, wherein the slot is configured such that the first edge of the conveyor belt can pass in a direction of belt travel while preventing movement of the first edge in a normal direction.

23. A method for driving a conveyor, comprising:
providing a drive belt having a plurality of mating portions for engaging an edge of a conveyor belt;
engaging the mating portions with a portion of the edge of the conveyor belt; and
using the drive belt to advance the conveyor belt.

24. The method of claim 23, further comprising:
providing a second drive belt having a plurality of mating portions for engaging a second edge of the conveyor belt;
engaging the mating portions of the second drive belt with a portion of the second edge of the conveyor belt; and
using the second drive belt to advance the conveyor belt.
